(19) United States
(12) Patent Application Publication
(10) Pub. No.: US 2024/0251934 A1
(43) Pub. Date: Aug. 1, 2024

(54) ELECTRIC TOOTHBRUSH

(71) Applicant: QUIP NYC INC, Brooklyn, NY (US)

(72) Inventors: Simon J.M. ENEVER, Brooklyn, NY (US); Jonathan Henry FRATTI, Brooklyn, NY (US); Nathan A. HERRMANN, Brooklyn, NY (US); Michael J. LAWLOR, New York, NY (US); Louis A. FILOSA, Brooklyn, NY (US); Steffany V. TRAN, New York, NY (US); Luke S. MANSFIELD, New York, NY (US)

(21) Appl. No.: 18/430,641

(22) Filed: Feb. 1, 2024

Related U.S. Application Data
(60) Provisional application No. 63/442,712, filed on Feb. 1, 2023.

(51) Int. Cl. A46B 5/00; A46B 5/02; A46B 15/00

(52) U.S. Cl. CPC A46B 5/0095; A46B 5/02; A46B 15/0004; A46B 2200/1066

(57) ABSTRACT

According to one aspect, an electric toothbrush may include a handle defining a volume, a motor disposed in the volume defined by the handle, a shaft having a first end portion and a second end portion, the first end portion coupled to the motor in the volume, the second end portion extending from the volume of the handle and fluidically isolated from the volume of the handle and, with the second end portion fluidically isolated from the volume of the handle, the second end portion releasably engageable in mechanical communication with a cartridge including at least one dental cleaning element, and a sleeve conforming to an outer surface of the handle and circumscribing at least a portion of the shaft fluidically isolated from the volume of the handle.

### CROSS-REFERENCE TO RELATED APPLICATIONS

This application claims the benefit of priority of U.S. Provisional Patent Application No. 63/442,712, filed on Feb. 1, 2023, the entire contents of which are incorporated herein by reference.

### BACKGROUND

Toothbrushing is important for maintaining good oral health. A toothbrush typically includes a cleaning element and a handle coupled to one another via a shank. The cleaning element typically includes a plurality of bristles. With toothpaste applied to the plurality of bristles of the cleaning head, a user may grasp the handle to move the shank and, thus, the plurality of bristles in the user's mouth to clean the user's teeth, gum, and tongue. Although manual toothbrushes can be used to clean teeth, electric toothbrushes facilitate achieving superior and more consistent cleaning, potentially reducing incidences of dental diseases.

Cleaning elements of electric toothbrushes degrade over time and must be replaced. However, to isolate vibration of the cleaning elements from a user's hand grasping the electric toothbrush in use, the replaceable portions of electric toothbrushes typically extend well beyond the cleaning elements, thus resulting in wasted material each time the cleaning element of the electric toothbrush is replaced. Accordingly, there remains a need for more efficient use of material in replacing cleaning elements of electric toothbrushes.

### SUMMARY

According to one aspect, an electric toothbrush may include a handle defining a volume, a motor disposed in the volume defined by the handle, a shaft having a first end portion and a second end portion, the first end portion coupled to the motor in the volume, the second end portion extending from the volume of the handle and fluidically isolated from the volume of the handle and, with the second end portion fluidically isolated from the volume of the handle, the second end portion releasably engageable in mechanical communication with a cartridge including at least one dental cleaning element, and a sleeve conforming to an outer surface of the handle and circumscribing at least a portion of the shaft fluidically isolated from the volume of the handle.

In some implementations, the handle may be formed of a first material having a first Shore durometer, at least a portion of the sleeve conforming to the outer surface of the handle is formed of a second material having a second Shore durometer less than the first Shore durometer.

In certain implementations, the sleeve may be formed of at least one liquid silicone rubber. Additionally, or alternatively, the sleeve may be seamless.

In some implementations, the sleeve may define a first aperture and a second aperture, the first aperture receiving a portion of the handle and, with the cartridge releasably securable in mechanical communication with the shaft through the second aperture of the sleeve. The sleeve may be releasably securable about at least the outer surface of the handle. Further, or instead, the sleeve may be elastically deformable between the first aperture and the second aperture and at least about the outer surface of the handle. In some implementations, the electric toothbrush may further include a clip on a portion of the sleeve conforming to the outer surface of the handle. The clip may cover the first aperture of the sleeve. Further, or instead, the clip may be held in place via friction and/or an adhesive between the clip and the portion of the sleeve conforming to the outer surface of the handle. In some instances, the clip may be resiliently flexible to spring bias the clip toward the portion of the sleeve conforming to the outer surface of the handle. In certain instances, the clip may include a U-shape, and legs of the U-shape are angled toward one another. Additionally, or alternatively, the clip may include steel, aluminum, plastic, or a combination thereof.

In certain implementations, the electric toothbrush may further include a base supported on the second end portion of the shaft, wherein the second end portion of the shaft is engageable in mechanical communication with the cartridge via at least the base. As an example, the base may define an orifice circumscribing at least a portion of the cartridge in mechanical communication with the second end portion of the shaft. In some instances, the cartridge may be releasably engageable with the second end portion of the shaft within the orifice defined by the base. The cartridge may for example, include a stem releasably engageable in snap or press fit engagement with the second end portion of the shaft, the base, or a combination thereof. As an example, the cartridge may be rotatable to secure the stem in snap or press fit engagement with the second end portion of the shaft, the base, or a combination thereof. Further, or instead, the cartridge may be releasably engageable in snap or press fit engagement with the base. The cartridge may be snap-fit against the base such that the cartridge fluidically seals the second aperture of the sleeve. In certain instances, the sleeve and the base may be co-molded to one another.

In some implementations, the electric toothbrush may further include a neck plate supported on the sleeve, wherein the sleeve is formed of a first polymer having a first elastic modulus, and the neck plate is formed of a second polymer having a second elastic modulus greater than the first elastic modulus. In some instances, the first polymer of the sleeve and the second polymer of the neck plate may be co-molded to one another.

In certain implementations, the handle may include a first section and a second section, wherein the first section and the second section are mechanically coupled to one another along respective mating surfaces of the first section and the second section of the handle. In some instances, the handle may further include a double-sided adhesive, an elastomeric gasket, or a combination thereof disposed between the first section and the second section of the handle and forming a waterproof seal along the respective mating surfaces of the first section and the second section of the handle.

In some implementations, the electric toothbrush may further include a gasket supported on the handle, wherein the shaft extends through the gasket, the gasket is in contact with the shaft between the first end portion and the second end portion of the shaft, and the gasket fluidically seals a gap between the shaft and the handle.

In certain implementations, the electric toothbrush may further include a printed circuit board assembly (PCBA) disposed in the volume of the handle, the PCBA in electrical communication with the motor, and the PCBA configured to control the motor. As an example, the electric toothbrush may further include at least one capacitive touch sensor disposed in the volume of the handle, wherein the at least one capacitive touch sensor is in electrical communication with the PCBA, and the PCBA is further configured to receive a first user input from the at least one capacitive touch sensor and to control the motor based on the first user input received from the at least one capacitive touch sensor. In some instances, the PCBA may be further configured to selectively disable user input via the capacitive touch sensor based on the motor being in an actuated state. In certain instances, the electric toothbrush may further include an inertial motion unit disposed in the volume of the housing and in electrical communication with the PCBA, wherein the PCBA is further configured to receive, from the inertial motion unit, a signal indicative of motion of the handle, and to selectively disable user input via the at least one capacitive touch sensor further based on the signal indicative of motion of the handle. As an example, the inertial motion unit may include an accelerometer, a gyroscope, or a combination thereof. In some instances, the PCBA may be further configured to receive a second user input from the at least one capacitive touch sensor, based on the second user input, to initiate a real-time clock countdown for a predetermined period associated with changing the cartridge, and to provide an alert to the user at the end of the predetermined period. In certain instances, the handle may include a translucent section, the LED light bar disposed in the volume of the handle and adjacent to the translucent section of the handle in the volume, and the PCBA is further configured to determine a state of the motor and to control the LED light bar based on a state of the motor. In some instances, the electric toothbrush may further include a pressure sensor in mechanical communication with the shaft, wherein the PCBA is further configured to receive, from the pressure sensor, a signal indicative of pressure during a brushing session and to control the light bar based on the signal indicative of pressure during the brushing session, with control of the light bar providing feedback to the user. As an example, the pressure sensor may include a strain gauge, a pressure switch, or a combination thereof.

In some implementations, the second end portion of the shaft may be elongate and releasably engageable with the cartridge via at least snap-fit or press fit engagement of the cartridge onto the second end portion of the shaft. As an example, the second end portion of the shaft may have an increasing cross-sectional dimension in an axial direction toward the handle, and the cartridge is slidable, in the axial direction, into snap fit or press fit engagement onto the second end portion of the shaft.

In certain implementations, the motor may be a sonic vibration motor actuatable to vibrate the first end portion of the shaft in the volume of the handle, and the shaft transmits vibration of the first end portion of the shaft to the at least one dental cleaning element of the cartridge via the second end portion of the shaft.

In certain implementations, the electric toothbrush may further include a rechargeable battery disposed in the volume of the handle, the rechargeable battery in electrical communication with the motor in the volume of the handle. In some instances, the electric toothbrush may further include charging coils disposed in the volume of the handle, the rechargeable battery and the charging coils are in electrical communication with one another, and the rechargeable battery is rechargeable via electromagnetic induction directed, through material of the handle, to the charging coils.

In some implementations, the electric toothbrush may further include the cartridge releasably secured in mechanical communication with the second end portion of the shaft. As an example, the at least one dental cleaning element may include bristles, and the bristles may extend in a direction away from the second end portion of the shaft.

In certain implementations, the electric toothbrush may further include an end cap, wherein the end cap defines an opening, the sleeve is a continuous silicon tube, and the opening of the end cap and the first aperture of the sleeve are releasably engageable with one another to form a seam circumscribing the handle with the end cap covering an end of the handle opposite the shaft extending from the handle.

According to another aspect, a toothbrush may include a handle, a shaft having a first end portion and a second end portion, the first end portion of the shaft coupled to the handle with the second end portion of the shaft extending away from the handle, a base supported on the second end portion of the shaft, the base defining an orifice, a cartridge including a stem and at least one dental cleaning element, the stem releasably securable in snap or press fit engagement with the orifice of the base with the at least one dental cleaning element extending away from the base.

In certain implementations, the toothbrush may further include a motor supported by the handle, wherein the motor is in mechanical communication with the cleaning head with the cleaning head in snap or press fit engagement with the orifice of the base. As an example, the shaft may define a longitudinal axis, and the stem of the cartridge is releasably securable in snap or press fit engagement with orifice of the base via at least movement of the stem of the cartridge parallel to the longitudinal axis in the orifice of the base. Further, or instead, the stem of the cartridge may be releasably securable in snap or press fit engagement with the orifice of the base via a combination of rotation of the stem in the orifice of the base and axial movement of the stem in a direction parallel to the longitudinal axis of the shaft. In some instances, the stem of the cartridge may be releasably securable in snap or press fit engagement with the orifice of the base in a two-stage coupling in which the cartridge is rotatable, about a rotation axis perpendicular to the base, into an initial engagement with the orifice of the base in a first stage of the two-stage coupling and the stem of the cartridge is axially slidable, parallel to the longitudinal axis of the shaft, into the snap or press fit engagement with the base in a second stage of the two-stage coupling. As an example, the cartridge may be axially slidable, parallel to the longitudinal axis of the shaft, into the snap or press fit engagement only with the initial engagement established between the cartridge and the base. Further, or instead, the cartridge may be rotatable by 90 degrees about the rotation axis into the initial engagement with the orifice of the base in the first stage of the two-stage coupling. Additionally, or alternatively, the cartridge may be bidirectionally rotatable about the rotation axis into the initial engagement of the stem with the orifice of the base in the first stage of the two-stage coupling. Still further, or instead, the cartridge may be rotatable in only one direction about the rotation axis into the initial engagement of the stem with the orifice of the base in the first stage of the two-stage coupling.

According to yet another aspect, a controller for an electric toothbrush may include one or more processors, and a memory including at least one non-transitory, computer-readable storage medium communicatively coupled to the one or more processors, the at least one non-transitory, computer-readable storage medium having stored thereon instructions for causing the one or more processors to carry out processes including receiving a signal indicative of motion of the electric toothbrush, during a predetermined period following actuation of a motor of the electric toothbrush, determining whether a cartridge is improperly installed on the electric toothbrush, and initiating a remedial action if the cartridge is determined to be improperly installed on the electric toothbrush.

In some implementations, determining whether the cartridge is improperly installed on the electric toothbrush may include detecting high frequency vibration associated with improper installation of the cartridge.

In certain implementations, determining whether the cartridge is improperly installed may be further based on current of the motor in the actuated state.

In certain implementations, initiating the remedial action may include deactivating or pulsing the motor.

In some implementations, initiating the remedial action may include providing an output to one or more light emitting diodes carried on the electric toothbrush and visible to the user of the electric toothbrush.

According to still another aspect, a dental hygiene system may include an electric toothbrush including a handle, charging coils, a rechargeable battery, and a first set of magnets, the handle defining a volume, the first set of magnets disposed in the volume, the charging coils and the rechargeable battery in electric communication with one another and each disposed in the volume, a mount including a second set of magnets, the mount securable to a vertical surface, and a charger including circuitry and a third set of magnets, the circuitry actuatable to charge the rechargeable battery of the electric toothbrush via electromagnetic induction with the handle of the electric toothbrush supported on a surface of the charger, and the electric toothbrush is securable to the mount and the charger, collectively and individually, via alignment of the first set of magnets with one or both of the second set of magnets and the third set of magnets.

In some implementations, the electric toothbrush may be directly securable to the charger with the first set of magnets and the third set of magnets aligned with one another.

In certain implementations, the electric toothbrush may be directly securable to the mount with the first set of magnets and the second set of magnets aligned with one another.

In some implementations, the charger may be directly securable to the mount with the second set of magnets and the third set of magnets aligned with one another. Further, or instead, with the charger directly secured to the mount, the electric toothbrush may be indirectly securable to the mount with the first set of magnets, the second set of magnets, and the third set of magnets aligned with one another.

In certain implementations, the mount may include an adhesive on a portion of the mount away from a mounting surface of the mount.

### BRIEF DESCRIPTION OF THE DRAWINGS

FIG. 1A is a perspective view of an electric toothbrush, shown with a cartridge releasably engaged in mechanical communication with the electric toothbrush.

FIG. 1B is a side view of a cross-section of the electric toothbrush of FIG. 1A, the cross-section taken along 1B-1B in FIG. 1A.

FIG. 1C is a perspective view of the cross-section of the electric toothbrush in FIG. 1B, shown close-up along area of detail 1C in FIG. 1B.

FIG. 1D is a perspective view of a sleeve of the electric toothbrush of FIG. 1A.

FIG. 1E is a bottom view of the sleeve of FIG. 1E.

FIG. 1F is a perspective view of a cross-section of the sleeve of FIG. 1D, the cross-section taken along 1F-1F in FIG. 1D.

FIG. 1G is a side view of a cross-section of the sleeve of FIG. 1D, the cross-section taken along 1G-1G in FIG. 1D.

FIG. 1H is a perspective view of a portion of the electric toothbrush of FIG. 1A, shown with the sleeve and a clip removed.

FIG. 1I is a perspective view of a portion of the electric toothbrush of FIG. 1H, shown with the handle removed.

FIG. 1J is a side view of the portion of the electric toothbrush of FIG. 1I.

FIG. 1K is a rear view of the portion of the electric toothbrush of FIG. 1I.

FIG. 1L is a schematic representation of a controller implemented on a PCBA of the electric toothbrush of FIG. 1A, the controller including one or more processors and one or more non-transitory computer-readable storage media.

FIG. 2 is a flowchart of an exemplary method of controlling a capacitive touch sensor of an electric toothbrush.

FIGS. 3A-3E are schematic representations of a temporal sequence showing releasable securement of a cartridge to a base supported on a shaft of the electric toothbrush of FIG. 1A, with the schematic representations of FIGS. 3A-3E shown in a front perspective view of the electric toothbrush of FIG. 1A.

FIG. 4A-4C are schematic representations corresponding to a portion of the temporal sequence shown in FIGS. 3A-3E, with the schematic representations of FIGS. 4A-4C shown in a rear view of the electric toothbrush of FIG. 1A with portions of the electric toothbrush of FIG. 1A removed to show engagement of the cartridge with an orifice defined the base.

FIG. 5 is a flowchart of an exemplary method of detecting installation of a cartridge on an electric toothbrush.

FIG. 6 is a schematic representation of a dental hygiene system including an electric toothbrush, a mount, and a charger.

FIG. 7 is a perspective view of a portion of an electric toothbrush including a sleeve and a neckplate.

FIG. 8A is a perspective view of an electric toothbrush including a sleeve and a cap, with the sleeve and the cap shown engaged with one another and forming a seam circumscribing a handle of the electric toothbrush.

FIG. 8B is a partially exploded perspective view of the electric toothbrush of FIG. 8A, shown with the sleeve and the cap exploded relative to the handle of the electric toothbrush.

FIG. 9 is an exploded view of an electric toothbrush including a handle, a shaft, and a sleeve.

FIG. 10 is a schematic representation of a cartridge releasably engageable with a shaft of an electric toothbrush.

FIG. 11A is a perspective view of a shaft extending in an orifice defined by a base of an electric toothbrush.

FIG. 11B is a rear view of a cartridge in snap fit engagement with the shaft of the electric toothbrush of FIG. 11A.

FIGS. 11C-11E are schematic representations of a temporal sequence showing the securement of the cartridge in snap-fit engagement with the shaft of the electric toothbrush of FIG. 11A.

Like reference symbols in the various drawings indicate like elements.

### DETAILED DESCRIPTION

Embodiments will now be described more fully hereinafter with reference to the accompanying figures, in which exemplary embodiments are shown. The foregoing may however, be embodied in many different forms and should not be construed as limited to the exemplary embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

In the description that follows, devices, systems, and methods are generally described in the context of electric toothbrushes for the sake of clear and efficient description of various features. Unless otherwise specified or made clear from the context, it should be more generally understood that devices, systems, and methods described herein may be used in the context of other types of dental care devices. Thus, for example, unless a contrary intent is explicitly set forth, the devices, systems, and methods described herein may be used in the context of oral irrigators. Further, or instead, unless otherwise specified or made clear from the context, aspects of toothbrushes described herein may be implemented as manual toothbrushes.

Further, or instead, unless otherwise specified or made clear from the context, the term “mechanical communication” is used herein to refer to both direct mechanical coupling between two components and to indirect mechanical coupling between two components. In particular, two components shall be understood to be in mechanical communication with one another via indirect mechanical coupling in which one or more components are between the two components but mechanical force is transmitted between the two components that are indirectly mechanically coupled to one another. As a specific example, two components shall be understood to be in mechanical communication with one another, even with gaskets or other types of components disposed between the two components, provided that at least some mechanical force is intended to be transmitted in at least one direction between the two components.

For the sake of clear and efficient description, elements with numbers having the same last two digits in the disclosure that follows shall be understood to be analogous to or interchangeable with one another, unless otherwise explicitly stated or made clear from the context and, therefore, are not described separately from one another, except to note difference or to emphasize certain features. Thus, for example, a sleeve 108 of an electric toothbrush 100 and a sleeve 808 of an electric toothbrush 800 shall be understood to be analogous to or interchangeable with one another, unless otherwise specified or made clear from the context.

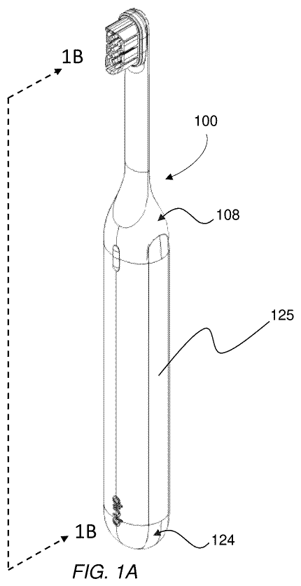

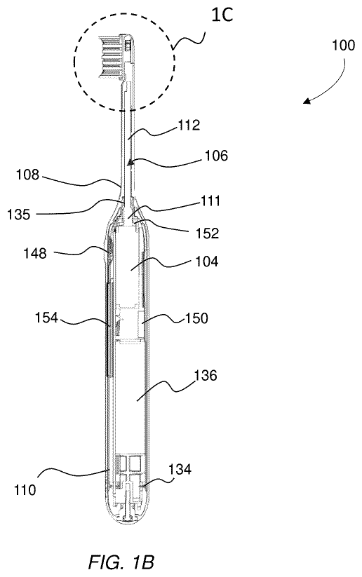

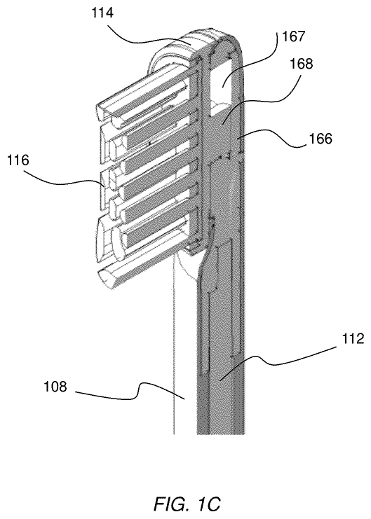

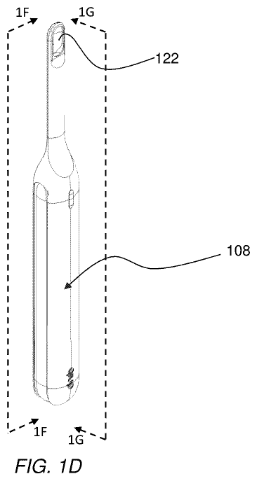

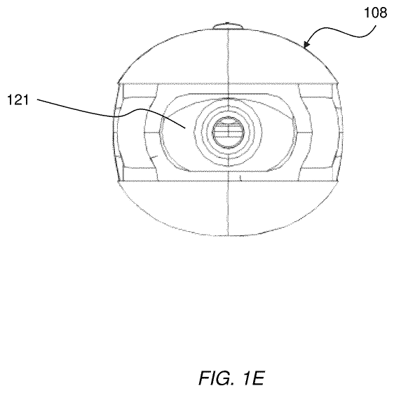

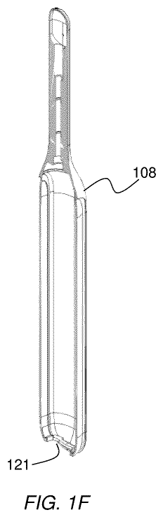

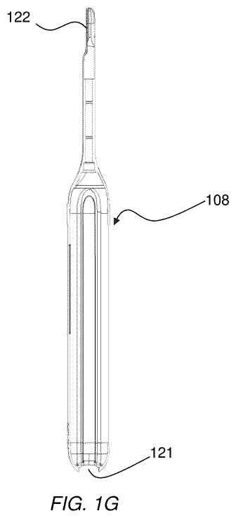

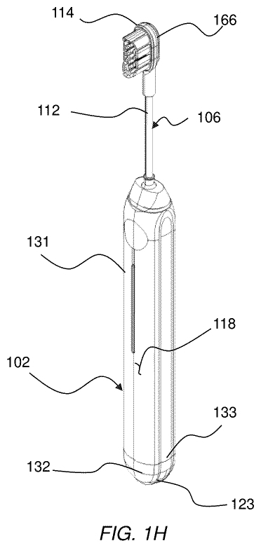

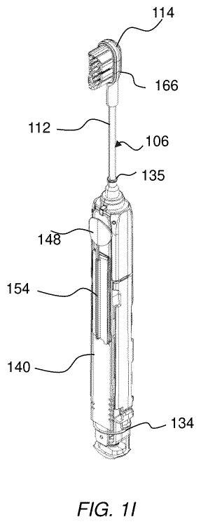

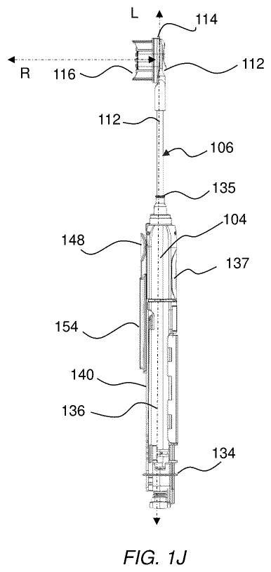

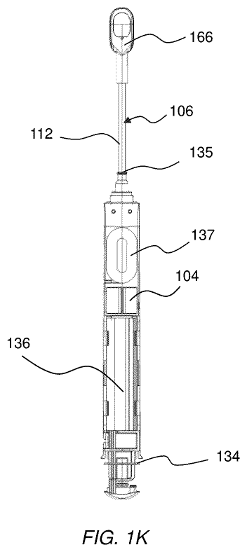

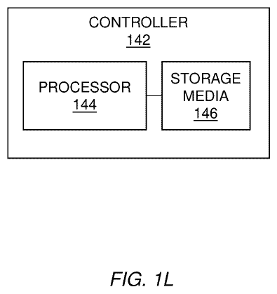

Referring now to FIGS. 1A-1L, an electric toothbrush 100 may include a handle 102, a motor 104, a shaft 106, and a sleeve 108. The handle 102 may define a volume 110, and the motor 104 may be disposed in the volume 110 defined by the handle 102. The shaft 106 may have a first end portion 111 and a second end portion 112. The first end portion 111 may be coupled to the motor 104 in the volume 110. The second end portion 112 of the shaft 106 may extend from the volume 110 of the handle 102 while being fluidically isolated from the volume 110 of the handle 102. With the second end portion 112 of the shaft 106 fluidically isolated from the volume 110 of the handle 102, the second end portion 112 of the shaft 106 may be in mechanical communication (e.g., directly and/or indirectly mechanically coupled) with a cartridge 114 including at least one dental cleaning element 116 (e.g. bristles). The shaft 106 extending from the motor 104 in the volume 110 of the handle 102 to the cartridge 114 outside of the volume 110 may facilitate transmitting vibration from the motor 104 within the volume 110 to the at least one dental cleaning element 116 of the cartridge 114. Further, or instead, the sleeve 108 may conform to an outer surface 118 of the handle 102 and, in some instances, may circumscribe at least a portion of the shaft 106 fluidically isolated from the volume 110 of the handle 102. Thus, the sleeve 108 may isolate the vibration output at the cartridge 114 and dampen vibration along the handle 102. That is, the sleeve 108 may localize vibration at the cartridge 114 while dampening vibration away from the cartridge 114—such as along the handle 102—to reduce vibration transmitted to the hand of a user grasping the handle 102 during brushing. Additionally, or alternatively, the sleeve 108 may reduce the likelihood of hard plastic collision with a user's teeth at high frequencies. Still further, or instead, as compared to an electric toothbrush with a rigid outer shell, the sleeve 108 may facilitate a robust connection between the cartridge 114 and the sleeve 108, with such a robust connection potentially offering advantages with respect to cleaning the electric toothbrush 100.

In use, as described in greater detail below, the cartridge 114 may be releasably engageable with the second end portion 112 of the shaft 106 such that the cartridge 114 may be periodically replaced as the at least one dental cleaning element 116 wears down and/or prophylactically to facilitate maintaining effective brushing results over long periods of time. As compared to the use of a short shaft that connects to a shank of a brush head to transmit vibration to a cleaning element via the shank of the brush head, the cartridge 114 may be much smaller than a brush head that includes shank of a toothbrush. Thus, periodic replacement of the cartridge 114 may result in more efficient use of material, as compared to periodic replacement of a larger brush head.

In general, the sleeve 108 may be formed of any one or more biocompatible materials that are resistant to water and mild cleaning agents while also dampening vibrations and otherwise promoting grasping by a user. As an example, the handle 102 may be formed of a relatively rigid material having a first Shore durometer to facilitate protecting components (e.g., the motor 104) within the volume 110 and/or to reduce the likelihood of misalignment of components within the volume 110 over time. Continuing with this example, the sleeve 108 may be formed of a relatively soft material having a second Shore durometer, less than the first Shore durometer on a given Shore scale, to facilitate dampening vibration transmitted from the motor 104 to an outer surface 118 of the handle 102. That is, the relatively soft material of the sleeve 108 may be between the hand of the user and the outer surface 118 of the handle 102 as the user grasps the handle 102 during brushing. In certain implementations, the sleeve may be formed of at least one liquid silicone rubber, which has a useful combination of softness, durability, and cost-effectiveness.

In some instances, the sleeve 108 may be seamless. For example, the sleeve 108 may be formed as a unitary construction without seams associated with one or more secondary operations associated with bonding portions of material of the sleeve 108. Such seamless construction of the sleeve 108 may among other things, reduce the likelihood of ripping or tearing that may otherwise preferentially occur at seams as the sleeve 108 is positioned onto the outer surface 118 of the handle 102 (e.g., during manufacturing and/or by the end-user as part of routine maintenance or repair).

In certain implementations, the sleeve 108 may define a first aperture 121 and a second aperture 122, as may be useful for slipping the sleeve 108 onto the handle 102 while providing access for the cartridge 114 to be mechanically coupled to the second end portion 112 of the shaft 106 according to any one or more of the various different techniques described herein. The first aperture 212 may receive at least a portion of the handle 102 such that the handle 102 and the shaft 106 may be inserted into the sleeve 108. As a specific example, the handle 102 may be inserted into the sleeve 108 with the second end portion 112 of the shaft 106 extending away from the handle 102. Continuing with this example, the sleeve 108 may be positioned over the handle 102 such that an end 123 of the handle 102 opposite the second end portion 112 of the shaft 106 is facing toward the first aperture while the second end portion 112 of the shaft 106 is facing toward the second aperture 122. In some instances, the cartridge 114 may be releasably securable in mechanical communication with the second end portion 112 of the shaft 106 through the second aperture 122 of the sleeve 108, as described in greater detail below.

In certain instances, the sleeve 108 may be releasably securable about at least the outer surface 118 of the handle 102, as may be useful for cleaning the sleeve 108 and/or the outer surface 118 of the handle 102. As an example, the sleeve 108 may be formed of one or more materials having a high coefficient of friction with respect to material of the outer surface 118 of the handle 102 such that friction the sleeve 108 and the outer surface 118 of the sleeve 108 reduces the likelihood of relative movement between the sleeve 108 and the handle 102 during a brushing operation. Further, or instead, the sleeve 108 may be elastically deformable between the first aperture 121 and the second aperture 122. Such elastic deformation may be useful for stretching the sleeve 108 over the outer surface 118 of the handle 102 during manufacturing and/or by the end-user. Additionally, or alternatively, elastic deformability of the sleeve 108 may be useful creating tension in the sleeve 108 as the sleeve 108 at least along the outer surface 118 of the handle 102, with the tension reducing the likelihood of unintended relative movement between the sleeve 108 and the outer surface 118 of the handle 102 during a brushing operation.

In certain implementations, the electric toothbrush 100 may additionally, or alternatively, include one or more components that facilitate securing (e.g., permanently and/or releasably) the sleeve 108 relative to the outer surface 118 of the handle 102 and/or cover the first aperture 121 when the handle 102 disposed in the sleeve 108. As an example, the electric toothbrush 100 may include a clip 124 on a portion of the sleeve 108 conforming to the outer surface 118 of the handle 102.

In general, the clip 124 may be held in placed on the sleeve 108 using any one or more of various, different securement techniques. In certain instances, the clip 124 may be held in place on the sleeve 108 via friction and/or an adhesive between the clip 124 and the portion of the sleeve 108 conforming to the outer surface 118 of the handle 102. Further, or instead, the clip 124 may be resiliently flexible to spring bias the clip 124 toward the portion of the sleeve 108 conforming to the outer surface 118 of the handle 102. As an example, the clip 124 may include a U-shape in which legs 125 of the U-shape are angled toward one another, providing spring bias useful for holding the sleeve 108 in place relative to the outer surface 118 of the handle 102.

The clip 124 may generally be formed of any one or more materials compatible with contacting the sleeve 108 while remaining robust and in place throughout brushing operations. Thus, for example, the clip 124 may be formed of one or more materials that are inexpensive yet aesthetically differentiable from one another, as may be useful in a household in which there are multiple instances of the electric toothbrush 100. As specific examples, the clip 124 may include steel, aluminum, plastic, or a combination thereof.

In general, the handle 102 may have a form factor that is comfortably graspable by a user during a brushing operation while also accommodating various electrical components carrying out various functions described herein (e.g., repeated movement of the cartridge 114, sensing one or more aspects of the brushing operation, and/or providing feedback to the user). Further, or instead, the handle 102 may be rigid and may support electrical components fixed relative to one another within the volume 110, as may be useful for reducing the likelihood of electrical components becoming damaged and/or disconnected from one another by forces normally associated with brushing, routine handling, recommended cleaning, and replacing the cartridge 114.

In certain instances, the handle 102 may include a plurality of sections to facilitate efficient and accurate placement of components within the volume 110 during manufacturing at high production volumes. For example, the handle 102 may include a first section 131 and a second section 132. During manufacturing, components may be positioned relative to the first section 131 of the handle 102 and/or relative to the second section 132 of the handle 102 such one or more features of the first section 131 and/or the second section 132, as the case may be, may act as a positioning landmarks for placement of components relative to one another. With the components so positioned, the first section 131 and the second section 132 of the handle 102 may be mechanically coupled to one another along respective mating surfaces 133 on the first section 131 and the second section 132 of the handle 102 to define the volume 110 with components disposed therein, as described in the present disclosure.

The handle 102 may be generally sealed to reduce or eliminate ingress of liquid and other foreign matter into the volume 110, thus protecting components in the volume 110 from exposure to such liquid and foreign matter and the damage and/or degradation associated with this exposure. That is, to facilitate robust use of the electric toothbrush 100 over repeated brushing operations, the handle 102 may have a watertight seal while also accommodating the shaft 106 extending from the volume 110 to the cartridge 114. As an example, a seal (e.g., a double-sided adhesive and/or one or more elastomeric gaskets) may be disposed between the first section and the second section of the handle 102, with the seal forming a waterproof seal along the respective mating surfaces 133 of the first section 131 and the second section 132 of the handle 102. Further or instead, a gasket 135 may be supported on the handle 102 with the shaft 106 extending through the gasket 135. The gasket 135 may be, for example, in contact with the shaft 106 between the first end portion 111 and the second end portion 112 of the shaft 106 such that the gasket 135 fluidically seals a gap between the shaft 106 and the handle 102.

In general, the motor 104 disposed in the volume 110 of the handle 102 may be any one or more of various, different types of motors operable to transform electrical energy into mechanical movement that is directly or indirectly transmittable to the cartridge 114 via the shaft 106 during brushing. As an example, the motor 104 may be a sonic vibration motor actuatable to vibrate the first end portion 111 of the shaft 106 in the volume 110 of the handle 102. Continuing with this example, the shaft 106 may transmit vibration of the first end portion 111 of the shaft 106 within the volume 110 of the handle 102 to the at least one dental cleaning element 116 of the cartridge 114 via the second end portion 112 of the shaft 106 outside of and fluidically isolated from the volume 110 of the handle 102.

In certain implementations, the electric toothbrush 100 may include a rechargeable battery 136 disposed in the volume 110 of the handle 102 and in electrical communication with the motor 104 in the volume 110 of the handle 102. As a lower constraint on size, the rechargeable battery 136 may be sized to provide enough power to the motor 104 and other electronics to support at least one brushing operation and associated user feedback. As an upper constraint on size, the rechargeable battery 136 may have a volume small enough to fit within the volume 110 of the handle 102, along with the motor 104 and other electrical components. Between these constraints on size, the rechargeable battery 136 may be sized to support many regular brushing operations (e.g., one or more weeks, one or more months, etc.) between charges, as may be useful for using the electric toothbrush 100 for traveling and/or while away from power sources from extended periods of time. As an example, the rechargeable battery 136 may be a lithium-ion battery.

In certain instances, the rechargeable battery 136 may be wirelessly rechargeable within the volume 110 of the handle 102. This may be useful for, among other things, maintaining the integrity of the liquid-tight seal of the volume 110 of the handle 102. As an example, the electric toothbrush 100 may include charging coils 137 disposed in the volume 110 of the handle 102. Continuing with this example, the rechargeable battery 136 may be rechargeable via electromagnetic induction directed, through material of the handle, to the charging coils in electrical communication with the rechargeable battery 136. As described in greater detail below, such recharging may be achieved by positioning the electric toothbrush 100 on a charger such that the charging coils 137 are in close physical proximity to circuitry of the charger to receive the electromagnetic induction.

In some implementations, the electric toothbrush 100 may include a printed circuit board assembly (PCBA) 140 disposed in the volume 110 of the handle 102. The PCBA 140 may include a controller 142 in electrical communication with any one or more of the rechargeable battery 136, the motor 104, the charging coils 137, sensors, input components, and/or output components described herein. The controller 142 may for example, included one or more processors 144 and one or more non-transitory computer-readable storage media 146 having stored thereon instructions for causing the one or more processors 144 to carry out any one or more aspects of operation of the electric toothbrush 100 described herein.

In certain implementations, the electric toothbrush 100 may include one or more sensors in electrical communication with the controller 142 to carry out any one or more of various different described herein for controlling the electric toothbrush 100, measuring brushing activity, and/or providing feedback to the user (e.g., during and/or after the brushing activity). These sensors may be generally arranged to remain robust—thus providing reliable and accurate performance—under conditions associated with brushing operations. Thus, in some instances, the sensors may be disposed in the volume 110 of the handle 102, where the sensors may have little or no exposure to water or other substances that may damage or degrade the sensors over time.

As an example, the electric toothbrush 100 may include at least one instance of a capacitive touch sensor 148 (hereafter referred to as the capacitive touch sensor 148 disposed in the volume 110 of the handle 102, and the user may provide input to the capacitive touch sensor 148 by touching a portion of the sleeve 108 corresponding to the position of the capacitive touch sensor 148 in the volume 110 of the handle 102. That is, the user may provide input to the capacitive touch sensor 148 without directly touching the capacitive touch sensor 148. As compared to the use of an external input button that may become dirty or otherwise worn down over time, the capacitive touch sensor 148 may be more robust for receiving input from the user. In general, the capacitive touch sensor 148 may be in electrical communication with the controller 142 of the PCBA 140 such that input received through the capacitive touch sensor 148 may be used to carry out any one or more of various operations described herein. By way of example and not limitation, the one or more non-transitory computer-readable storage media 146 may have stored thereon instructions for causing the one or more processors 144 to receive a first user input from the capacitive touch sensor 148 and to control the motor based on the user input received through the capacitive touch sensor 148. As an example, the capacitive touch sensor 148 may be used with a slider-like interaction such that, by swiping along a portion of the sleeve 108 corresponding to the position of the capacitive touch sensor 148 in the volume 110, the user may adjust a power setting of the motor 104 up or down, depending on the direction of swiping.

Further, or instead, the one or more non-transitory computer-readable storage media 146 may have stored thereon instructions for causing the one or more processors 144 to receive, from the capacitive touch sensor 148, a second user input, to initiate a real-time clock countdown for a predetermined period associated with changing the cartridge 114, and to provide an alert to the user at the end of the predetermined period. That is, the second user input may be indicative of a new instance of the cartridge 114 being installed on the electric toothbrush 100 (e.g., according to any one or more of the various, different techniques described herein), and the real-time clock countdown may count down until the instance of the cartridge 114 should be replaced (e.g., according to predetermined guidelines, user preferences, etc.). As an example, the predetermined period may be 3 months and the second user input may start a countdown that terminates in a reminder being provided to the user at the end of the 3-month period. The reminder may include any one or more of various, different types of outputs including haptic output and/or a visual signal transmitted by light emitting diodes (LEDS) described below.

Additionally, or alternatively, the electric toothbrush 100 may include an inertial motion unit 150 that senses motion of the handle 102 and, thus, motion of the cartridge 114 mechanically coupled to the handle 102 via the shaft 106. For example, the inertial motion unit 150 may determine whether the electric toothbrush 100 is being used in a brushing operation and, if so, may determine which quadrant of the user's mouth is being brushed at any given time during the brushing operation. The inertial motion unit 150 may include, by way of example, an accelerometer, a gyroscope, or a combination thereof.

Further, or instead, the electric toothbrush 100 may include a pressure sensor 152 that may among other things, detect pressure applied by the cartridge 114 to teeth of the user as the user uses the electric toothbrush 100 to perform a brushing operation. As an example, the pressure sensor 152 may include a strain gauge, a pressure switch, or a combination thereof. Further or instead, the pressure sensor 152 may detect pressure on the shaft 106—such as a portion of the shaft 106 away from the cartridge 114—such that the pressure of the cartridge 114 on the teeth of the user is determined indirectly. In some implementations, the one or more non-transitory computer readable storage media 146 may have stored thereon instructions for causing the one or more processors 144 to receive, from the pressure sensor 152, a signal indicative of pressure during a brushing session and to provide feedback to the user based on the signal indicative of pressure during the brushing session. For example, feedback to the user may indicate the brushing pressure is outside of a predetermined range (e.g., too high, too low) associated with good brushing habits. In some instances, feedback to the user may include haptic feedback. Further, or instead, feedback to the user may include visual feedback transmitted by light emitting diodes (LEDS) described below.

In some implementations, the electric toothbrush 100 may include one or more output components useful for providing the user with one or more of the various different alerts described herein—such as alerts associated with brushing performance, error conditions, reminders, etc. As an example, the electric toothbrush 100 may include a light emitting diode (LED) light bar 154 (hereafter, the LED light bar 154) disposed in the volume 110 of the handle 102, as may be useful for protecting the LED light bar 154 during brushing sessions. Continuing with this example, the handle 102 may include a translucent section in some implementations, and the handle 102 may include a translucent section adjacent to the LED light bar 154 such that the LED light bar 154 is visible along the outer surface 118 of the handle 102. The LED light bar 154 may include a plurality of LEDs operable in coordination with one another to provide any one or more of various, different visual indications (e.g., animations) to the user, with the various, different indications corresponding to different outputs to the user. For example, the LED light bar 154 may light up progressively during a brushing operation to provide the user with an indication of progress of the brushing operation. Further, or instead, the LED light bar 154 may be controlled to provide the user with an indication of pressure being applied during the brushing operation, a state of charge of the rechargeable battery 136, and/or a state (e.g., power setting) of the motor 104 during a brushing operation.

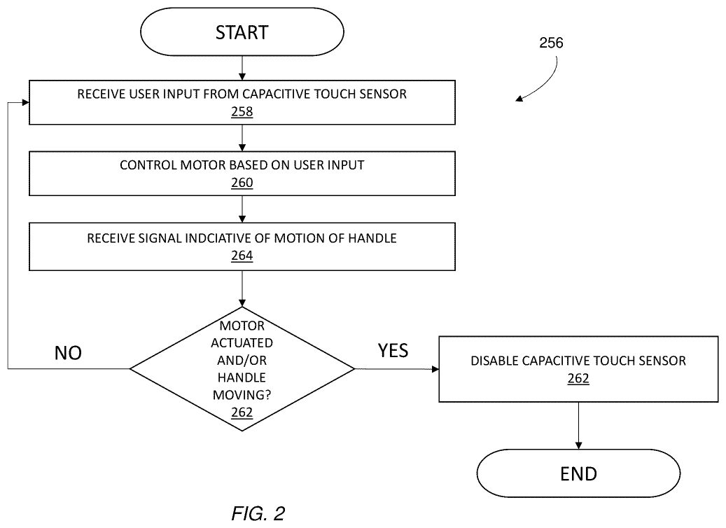

FIG. 2 is a flow chart of an exemplary method 256 of controlling a capacitive touch sensor of an electric toothbrush. Unless otherwise specified or made clear from the context, it shall be understood that any one or more of the various, different aspects of the exemplary method 256 may be carried out by the controller 142 (FIG. 1L) in electrical communication with the motor 104 (FIG. 1B), with the capacitive touch sensor 148 (FIG. 1B), and/or with the inertial motion unit 150 (FIG. 1B).

As shown in step 258, the exemplary method 256 may include receiving a first user input from at least one capacitive touch sensor. The first user input may be any one or more of various different types of predetermined touch patterns. For example, the first user input may include a steady touch for a predetermined period of time, a swipe, etc.

As shown in step 260, the exemplary method 256 may include controlling a motor of the electric toothbrush based on the first user input received from the at least one capacitive touch sensor. For example, based on the user input, the motor may be actuated from a deactivated state such that the motor is turned on and transmits vibration to a cartridge via a shaft of the electric toothbrush.

As shown in step 262, the exemplary method 256 may include, based on the motor being in the actuated state, selectively disabling user input via the capacitive touch sensor. Selectively disabling the capacitive touch sensor based on the motor being in the actuated state may be useful for, among other things, reducing the likelihood of or preventing the capacitive touch sensor from misinterpreting normal grasping of a handle of the electric toothbrush as a user input. That is, selectively disabling the capacitive touch sensor based on the motor being in the actuated state may balance competing considerations of allowing the user with a robust input interface while reducing the likelihood that the same interface may produce inadvertent interruptions of the brushing operation.

As shown in step 264, the exemplary method 256 may additionally, or alternatively, include receiving, from an inertial motion unit, a signal indicative of motion of the handle. In such implementations, selectively disabling user input via the capacitive touch sensor may be further based on the signal indicative of motion of the handle. For example, selectively disabling the user input via the capacitive touch sensor based on a combination of the motor being in an actuated state and the inertial motion unit indicating motion of the handle may provide for more robust deactivation of the capacitive touch sensor, resulting in fewer inappropriate deactivations than using only the actuation state of the motor as the basis for selectively deactivating the capacitive touch sensor. Stated differently, using a combination of the actuation state of the motor and the indication of motion of the handle, there may be fewer false positive indications of brushing that result in deactivating the capacitive touch sensor at a time that may frustrate an intent of the user (e.g., when the user is attempting to provide a legitimate input to the capacitive touch sensor).

Having described various aspects of electric toothbrushes including cartridges mechanically actuated via a shaft, attention is now directed to various aspects of selectively releasing cartridges from electric toothbrushes of the present disclosure.

Referring again to FIGS. 1A-1L, the electric toothbrush 100 may include a base 166 supported on the second end portion 112 of the shaft 106. The second end portion 112 of the shaft 106 may be engageable in mechanical communication with the cartridge 114 via at least the base 166. That is, vibration from the motor 104 in the volume 110 of the handle 102 may be transmitted to the cartridge 114 via the shaft 106 and the base 166 supported on the second end portion 112 of the shaft 106.

In general, the base 166 may provide a platform that may be convenient for relative orientation of one or more locking features of the base 166 and the cartridge 114 as the user manipulates the cartridge 114 to releasably engage the cartridge 114 to the base 166. Further, or instead, the base 166 may be useful for providing the user with purchase for disengaging one or more locking features of the base 166 and the cartridge 114 as the user manipulates the cartridge 114 to remove the cartridge 114 from the base 166 (e.g., to replace a used instance of the cartridge 114 with a new instance of the cartridge 114).

In some instances, the sleeve 108 and the base 166 may be co-molded to one another, as may be useful for maintaining the sleeve 108 in place during brushing operations. Additionally, or alternatively co-molding the base 166 and the sleeve 108 may be useful for reducing or eliminating possible sites for accumulation of debris in the vicinity of the base 166. Still further, or instead, co-molding the base 166 and the sleeve 108 may facilitate ease of cleaning the base 166 with the cartridge 114 releasably engaged with the base 166 and/or with the cartridge 114 removed from the base 166.

In certain implementations, the base 166 may define an orifice 167. With the cartridge 114 releasably engaged with the base 166, the orifice 167 may circumscribe at least a portion of the cartridge 114 in mechanical communication with the second end portion 112 of the shaft 106. For example, the cartridge 114 may include a stem 168 supported on a surface of the cartridge 114 opposite the at least one dental cleaning element 116. Continuing with this example, the stem 168 may be positionable in the orifice 167 of the base 166 to secure the cartridge 114 in mechanical communication with the second end portion 112 of the shaft 106 with the at least one dental cleaning element 116 extending in a direction away from the base 166.

In certain implementations, the cartridge 114 may be releasably engageable in snap fit or press fit engagement with the base 166, as may be useful for manually securing the cartridge 114 to the base 166 and reducing or eliminating the need for tools to replace the cartridge 114. Further, or instead, with the cartridge 114 snap or press fit to the base 166, the cartridge 114 may fluidically seal the second aperture 122 of the sleeve 108, as may be useful for reducing the likelihood of liquid ingress into the sleeve 108 (and along the second end portion 112 of the shaft 106) during brushing. Returning to the example in which the base 166 defines the orifice 167, the stem 168 of the cartridge 114 may be inserted into the orifice 167 of the base 166, and the stem 168 may be snap or press fit to the base 166 along the orifice 167 of the base 166. Such insertion of the stem 168 of the cartridge 114 into the orifice 167 may be carried out by various, different types of movement of the stem 168 of the cartridge 114 relative to the orifice 167 of the base 166. For example, the cartridge 114 may be rotatable (e.g., clockwise, counterclockwise, or both) about a rotation axis R perpendicular to the base 166 to secure the stem 168 in snap or press fit engagement with the orifice 167 of the base 166. As a specific example, the cartridge 114 may be rotatable 90 degrees about the rotational axis R to secure the stem 168 in nap fit engagement with the orifice 167 of the base 166. Further, or instead, in the orifice 167 of the base 166, the stem 168 of the cartridge 114 may be movable in a direction parallel to a longitudinal axis L defined by the shaft 106 to secure the stem 168 in snap or press fit engagement with the second end portion 112 of the shaft 106.

While certain types of movement of the stem 168 of the cartridge 114 have been described, other types of movement may be additionally or alternatively used to secure the stem 168 of the cartridge 114 in snap or press fit engagement with the orifice 167 of the base 166. Further, or instead, the snap or press fit engagement of the stem 168 of the cartridge 114 with the base 166 along the orifice 167 may be established via a combination of rotation of the stem 168 in the orifice 167 and axial movement of the stem 168 in the orifice 167 in a direction parallel to the to the longitudinal axis L.

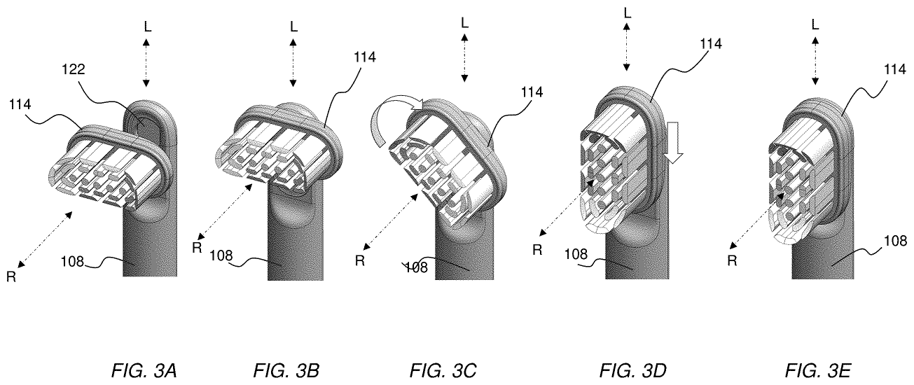

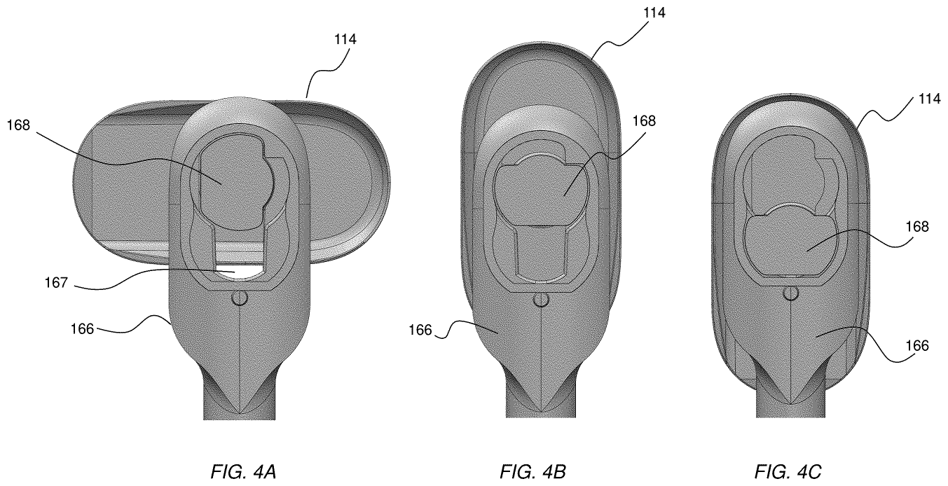

As an example, FIGS. 3A-3E and FIGS. 4A-4C, are each schematic representations of a temporal sequence showing snap or press fit engagement of the stem 168 of the cartridge with the orifice 167 of the base 166 in a two-stage coupling. FIGS. 3A-3E depict the temporal sequence from a front perspective view of the base 166 and the cartridge 114. FIGS. 4A-4C depict rear views of the base 166 and the cartridge 114 during the portion of the temporal sequence represented by FIGS. 3B, 3D, and 3E, with the sleeve 108 not shown in FIGS. 4A-4C for the sake of clarity of illustration.

As shown, the stem 168 of the cartridge 114 may be releasably securable in snap or press fit engagement with the orifice 167 of the base 166 in a two-stage coupling. In a first stage of the two-stage coupling (FIGS. 3A-3D and FIGS. 4A and 4B), the stem 168 is rotatable about the rotation axis R perpendicular to the base 166, into an initial engagement with the orifice 167 of the base 166. In certain implementations, the stem 168 may be rotatable in only one direction (e.g., clockwise or counterclockwise) in the orifice 167 of the base 166 to establish the first stage of the two-stage coupling. In other implementations, the stem 168 may be bidirectionally rotatable (e.g., clockwise and counterclockwise) in the orifice 167 of the base to establish the first stage of the two-stage coupling. Further, or instead, the stem 168 may be rotatable by less than 360 degrees about the rotation axis R into the initial engagement with the orifice 167 of the base 166 in the first stage of the two-stage coupling. For example, the stem 168 may be limited to rotate by only 90 degrees in any given rotational direction about the rotation axis R.

With the stem 168 engaged with the orifice 167 of the base 166 in this first stage of the two-stage coupling, the stem 168 is restricted from unintentionally moving out of the orifice 167 of the base 166, thus reducing the likelihood that the cartridge 114 may become unintentionally dislodged during a brushing operation and/or while the cartridge 114 is being replaced. In a second stage of the two-stage coupling (FIGS. 3D and 3E and FIGS. 4B and 4C), the stem 168 of the cartridge 114 is axially slidable, parallel to the longitudinal axis L of the shaft 106, into the snap or press fit engagement with the base 166.

As may be appreciated from the foregoing, the two-stage coupling of the stem 168 to the orifice 167 of the base 166 may be reversed to release the cartridge 114 from the base 166. In certain implementations, the cartridge 114 may be axially slidable, parallel to the longitudinal axis L of the shaft 106, into the snap press fit engagement only with the initial engagement establish between the cartridge 114 and the base 166. Stated differently, in some instances, the first stage and second stages of the two-stage coupling must each be carried out and must be carried out in order, as may be useful for reducing the likelihood of incorrect installation of the cartridge 114 on the base 166.

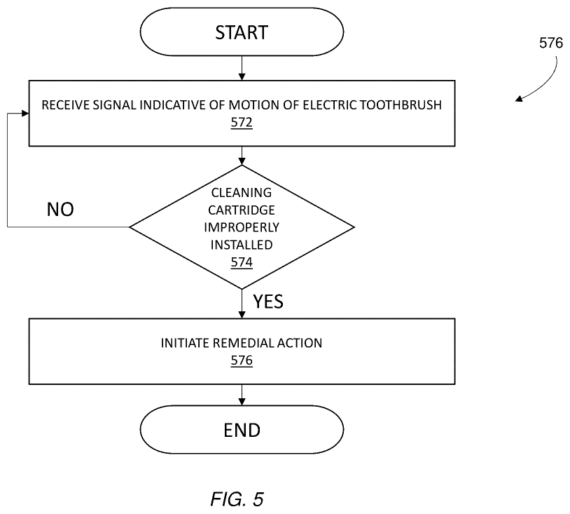

FIG. 5 is a flowchart of an exemplary method 570 of detecting installation of a cartridge on an electric toothbrush. Unless otherwise specified or made clear from the context, it shall be understood that any one or more of the various, different aspects of the exemplary method 570 may be carried out by the controller 142 (FIG. 1L) in electrical communication with the motor 104 (FIG. 1B) and/or with the inertial motion unit 150 (FIG. 1B).

As shown in step 572, the exemplary method 570 may include receiving a signal indicative of motion of an electric toothbrush during a predetermined period following actuation of a motor of the electric toothbrush. The signal may be received, for example, from one or more sensors including an accelerometer and/or a gyroscope (e.g., received from the inertial motion unit 150 (FIG. 1B).

As shown in step 574, the exemplary method 570 may include determining whether a cleaning cartridge is improperly installed on the electric toothbrush. For example, in instances in which the cleaning cartridge is releasably engageable with a base in mechanical communication with a shaft coupled to the motor of the electric toothbrush, the determination may be indicative of improper installation of the cartridge (e.g., incomplete and/or incorrect coupling between the cleaning cartridge and the base). In certain implementations, determining whether the cleaning cartridge is improperly installed on the electric toothbrush may include detecting high frequency vibration associated with improper installation of the cleaning cartridge. Further, or instead, determining whether the cleaning cartridge is improperly installed may be based on current of the motor in the actuated state.

As shown in step 576, the exemplary method 570 may include initiating a remedial action if the cleaning cartridge is determined to be improperly installed on the electric toothbrush. As an example, initiating the remedial action may include deactivating the motor (e.g., with deactivation persisting until the cartridge is properly installed), as may be useful for reducing the likelihood that the user will use the electric toothbrush to carry out a brushing operation with the cartridge installed improperly. Further, or instead, initiating the remedial action may include pulsing the motor, as may be useful for alerting the user. Still further, or instead, initiating the remedial action may include providing an output to one or more light emitting diodes carried on the electric toothbrush and visible to the user of the electric toothbrush (e.g., via the LED light bar 154 in FIG. 1H).

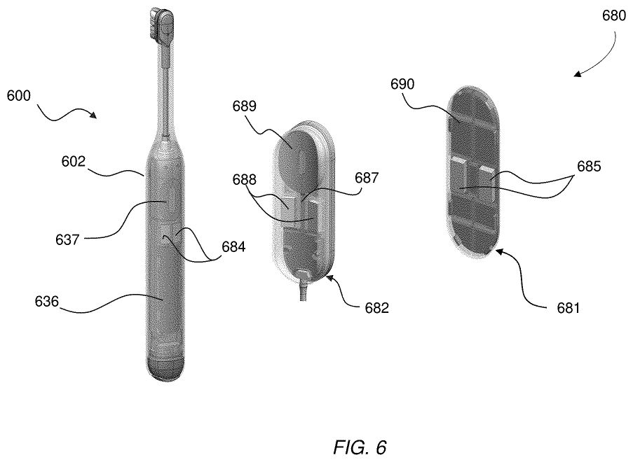

Referring now to FIG. 6, a dental hygiene system 680 may include an electric toothbrush 600, a mount 681, and a charger 682. The electric toothbrush 600 may include a handle 602, charging coils 637, and a first set of magnets 684. The mount 681 may include a second set of magnets 685, and the mount 681 may be securable to a vertical surface (e.g., a mirror, a wall, etc.). The charger 682 may include circuitry 687 actuatable and a third set of magnets 688. The circuitry 687 may be actuatable to charge the rechargeable battery 636 of the electric toothbrush 600 via electromagnetic induction with the handle 602 of the electric toothbrush supported on a surface 689 of the charger 682. Further, or instead, the electric toothbrush 600 may be securable to the mount 681 and the charger 682, collectively and individually, via alignment of the first set of magnets 684, with one or both of the second set of magnets 685 and the third set of magnets 688. As an example, the electric toothbrush 600 may be directly securable to the charger 682 with the first set of magnets 684 and the third set of magnets 688 aligned with one another. Further, or instead, the electric toothbrush 600 may be directly securable to the mount 681 (e.g., in a vertical orientation) with the first set of magnets 684 and the third set of magnets 688 aligned with one another. Still further, or instead, the charger 682 may be directly securable to the mount 681 (e.g., in a vertical orientation) with the second set of magnets 685 aligned with the third set of magnets 688. Additionally, or alternatively, with the charger 682 may be directly secured to the mount 681, the electric toothbrush 600 may be indirectly securable to the mount 681 (via the charger 682) with the first set of magnets 684, the second set of magnets 685, and the third set of magnets 688 aligned with one another. In some implementations, the mount 681 may include an adhesive on a portion of the mount 681 away from a mounting surface 690 of the mount 681.

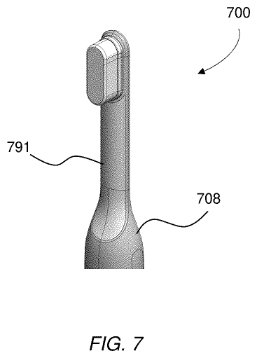

Referring now to FIG. 7, an electric toothbrush 700 may include a neck plate 791. For example, the neck plate 791 may be supported on a sleeve 708 such that the neck plate 791 may protect the sleeve 708 from degradation resulting from biting by the user during brushing operations. As a more specific example, the sleeve 708 may be disposed on the sleeve 708 away from a handle of the electric toothbrush 700. The sleeve 708 may be formed of a first polymer having a first elastic modulus, and the neck plate 791 may be formed of a second polymer having a second elastic modulus greater than the first elastic modulus. As an example, the first polymer of the sleeve 708 and the second polymer of the neck plate 791 may be co-molded to one another.

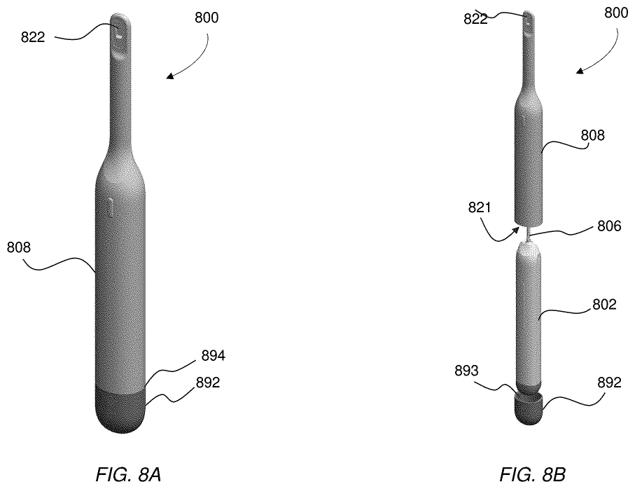

Referring now to FIGS. 8A and 8B, an electric toothbrush 800 may include a sleeve 808 and an end cap 892. The end cap 892 may define an opening 893. The sleeve 808 may be a continuous silicone tube defining a first aperture 821 and a second aperture 822. The opening 893 of the end cap 892 and the first aperture 821 of the sleeve 808 may be releasably engageable with one another to form a seam 894 circumscribing a handle 802 with the end cap 892 covering an end of the handle 802 opposite a shaft 806 extending from the handle 802.

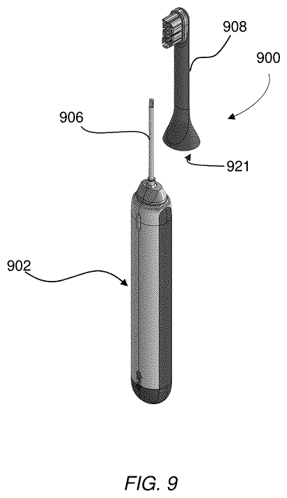

Referring now to FIG. 9, an electric toothbrush 900 may include a handle 902 and a sleeve 908. The sleeve 908 may be formed of silicone and may be shaped as a brush head. The sleeve 908 may define a first aperture 921 positionable over at least an end of the handle 902 from which a shaft 906 extends such that the sleeve 908 covers the shaft 906.

While certain implementations of releasable engagement of cartridges with shafts of electric toothbrushes have been described, other types of releasable engagement between cartridges and shafts of electric toothbrushes are additionally, or alternatively, possible. For example, cartridges may be additionally or alternatively releasably engageable with the shaft of the electric toothbrush in some instances.

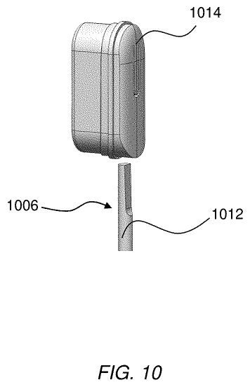

For example, referring now to FIG. 10, a second end portion 1012 of a shaft 1006 may be elongate and releasably engageable with a cartridge 1014 via at least snap-fit engagement of the cartridge 1014 onto the second end portion 1012 of the shaft 1006. Further, or instead, the second end portion 1012 of the shaft 1006 may have an increasing cross-sectional dimension in an axial direction toward a handle (not shown in FIG. 10) from which the shaft 1006 extends. The cartridge 1014 may be slidable in the axial direction into snap or press fit or press fit engagement onto the second end portion 1012 of the shaft 1006 in some instances.

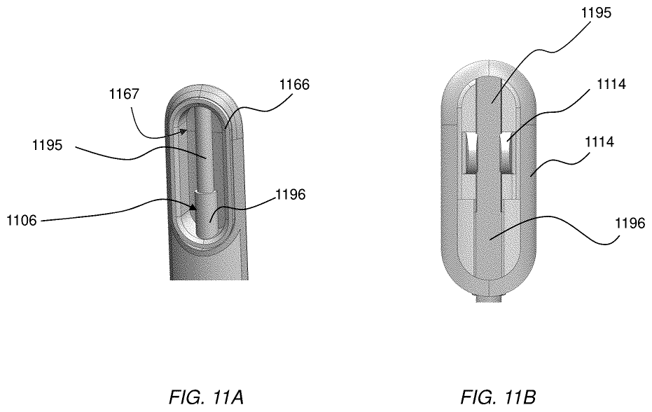

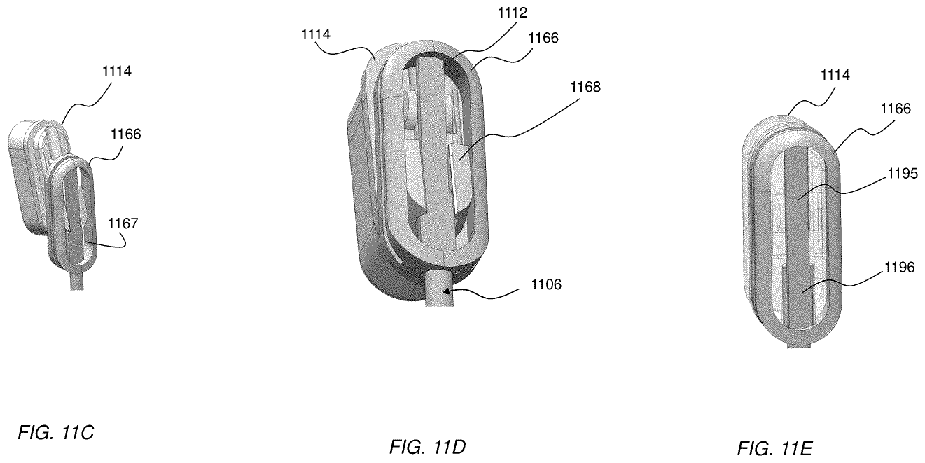

As another example, referring now to FIG. 11A-11E, a base 1166 may be supported on a second end portion 1112 of a shaft 1106. A cartridge 1114 may be releasably engageable with the second end portion 1112 of the shaft 1106 within an orifice 1167 defined by the base 1166. For example, the cartridge 1114 may have a stem 1168 with enough clearance to slide over a thin section 1195 of the second end portion 1112 of the shaft 1106. With the stem 1168 positioned on the thin section 1195 of the second end portion 1112 of the shaft 1106, the cartridge 1114 may be slid in an axial direction along the shaft 1106 to mate with a thick section 1196 of the second end portion 1112 of the shaft 1106. As an example, the stem 1168 of the cartridge 1114 may snap fit or press fit onto the thick section 1196 of the second end portion 1112 of the shaft 1106.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof and may be distributed across devices in a number of ways. At the same time, processing may be distributed across devices such as the various systems described above, or all of the functionalities may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity and need not be located within a particular jurisdiction.

While particular embodiments have been shown and described, it will be apparent to those skilled in the art that various changes and modifications in form and details may be made therein without departing from the spirit and scope of this disclosure and are intended to form a part of the invention as defined by the following claims.

What is claimed is:

1. An electric toothbrush comprising:
a handle defining a volume;
a motor disposed in the volume defined by the handle;
a shaft having a first end portion and a second end portion, the first end portion coupled to the motor in the volume, the second end portion extending from the volume of the handle and fluidically isolated from the volume of the handle and, with the second end portion fluidically isolated from the volume of the handle, the second end portion releasably engageable in mechanical communication with a cartridge including at least one dental cleaning element; and
a sleeve conforming to an outer surface of the handle and circumscribing at least a portion of the shaft fluidically isolated from the volume of the handle.

2. The electric toothbrush of claim 1, wherein the handle is formed of a first material having a first Shore durometer, at least a portion of the sleeve conforming to the outer surface of the handle is formed of a second material having a second Shore durometer less than the first Shore durometer.

3. The electric toothbrush of claim 1, wherein the sleeve is formed of at least one liquid silicone rubber.

4. The electric toothbrush of claim 1, wherein the sleeve defines a first aperture and a second aperture, the first aperture receiving a portion of the handle and, with the cartridge releasably securable in mechanical communication with the shaft through the second aperture of the sleeve.

5. The electric toothbrush of claim 4, further comprising a clip on a portion of the sleeve conforming to the outer surface of the handle.

6. The electric toothbrush of claim 5, wherein the clip covers the first aperture of the sleeve.

7. The electric toothbrush of claim 1, further comprising a base supported on the second end portion of the shaft, wherein the second end portion of the shaft is engageable in mechanical communication with the cartridge via at least the base.

8. The electric toothbrush of claim 7, wherein the base defines an orifice circumscribing at least a portion of the cartridge in mechanical communication with the second end portion of the shaft.

9. The electric toothbrush of claim 8, wherein the cartridge is releasably engageable with the second end portion of the shaft within the orifice defined by the base.

10. The electric toothbrush of claim 8, wherein the cartridge includes a stem releasably engageable in snap or press fit engagement with the second end portion of the shaft, the base, or a combination thereof.

11. The electric toothbrush of claim 10, wherein the cartridge is rotatable to secure the stem in snap or press fit engagement with the second end portion of the shaft, the base, or a combination thereof.

12. The electric toothbrush of claim 1, further comprising a printed circuit board assembly (PCBA) disposed in the volume of the handle, the PCBA in electrical communication with the motor, and the PCBA configured to control the motor.

13. The electric toothbrush of claim 12, further comprising at least one capacitive touch sensor disposed in the volume of the handle, wherein the at least one capacitive touch sensor is in electrical communication with the PCBA, and the PCBA is further configured to receive a first user input from the at least one capacitive touch sensor and to control the motor based on the first user input received from the at least one capacitive touch sensor.

14. The electric toothbrush of claim 13, wherein the PCBA is further configured to selectively disable user input via the capacitive touch sensor based on the motor being in an actuated state.

15. A toothbrush comprising:
a handle;
a shaft having a first end portion and a second end portion, the first end portion of the shaft coupled to the handle with the second end portion of the shaft extending away from the handle;
a base supported on the second end portion of the shaft, the base defining an orifice; and
a cartridge including a stem and at least one dental cleaning element, the stem releasably securable in snap or press fit engagement with the orifice of the base with the at least one dental cleaning element extending away from the base.

16. The toothbrush of claim 15, wherein the shaft defines a longitudinal axis, and the stem of the cartridge is releasably securable in snap or press fit engagement with orifice of the base via at least movement of the stem of the cartridge parallel to the longitudinal axis in the orifice of the base.

17. The toothbrush of claim 16, wherein the stem of the cartridge is releasably securable in snap or press fit engagement with the orifice of the base via a combination of rotation of the stem in the orifice of the base and axial movement of the stem in a direction parallel to the longitudinal axis of the shaft.

18. The toothbrush of claim 17, wherein the stem of the cartridge is releasably securable in snap or press fit engagement with the orifice of the base in a two-stage coupling in which the cartridge is rotatable, about a rotation axis perpendicular to the base, into an initial engagement with the orifice of the base in a first stage of the two-stage coupling and the stem of the cartridge is axially slidable, parallel to the longitudinal axis of the shaft, into the snap or press fit engagement with the base in a second stage of the two-stage coupling.

19. A controller for an electric toothbrush, the controller comprising:
one or more processors; and
a memory including at least one non-transitory, computer-readable storage medium communicatively coupled to the one or more processors, the at least one non-transitory, computer-readable storage medium having stored thereon instructions for causing the one or more processors to carry out processes including
receiving a signal indicative of motion of the electric toothbrush, during a predetermined period following actuation of a motor of the electric toothbrush,
determining whether a cartridge is improperly installed on the electric toothbrush, and
initiating a remedial action if the cartridge is determined to be improperly installed on the electric toothbrush.

20. A dental hygiene system comprising:
an electric toothbrush including a handle, charging coils, a rechargeable battery, and a first set of magnets, the handle defining a volume, the first set of magnets disposed in the volume, the charging coils and the rechargeable battery in electric communication with one another and each disposed in the volume;
a mount including a second set of magnets, the mount securable to a vertical surface; and
a charger including circuitry and a third set of magnets, the circuitry actuatable to charge the rechargeable battery of the electric toothbrush via electromagnetic induction with the handle of the electric toothbrush supported on a surface of the charger, and the electric toothbrush is securable to the mount and the charger, collectively and individually, via alignment of the first set of magnets with one or both of the second set of magnets and the third set of magnets.
